(19) United States
(12) Patent Application Publication
(10) Pub. No.: US 2014/0129315 A1
(43) Pub. Date: May 8, 2014

(54) Group Purchasing System

(71) Applicants: Paul Neely, London (GB); Dheeraj Bhardwaj, Dartford (GB)

(72) Inventors: Paul Neely, London (GB); Dheeraj Bhardwaj, Dartford (GB)

(73) Assignee: Shoplogics Limited, Dartford (GB)

(21) Appl. No.: 14/130,711

(22) PCT Filed: Jul. 25, 2012
(86) PCT No.: PCT/GB2012/051778

§ 371 Date: Jan. 3, 2014

(30) Foreign Application Priority Data
Jul. 27, 2011 (GB) 1112934.3

(51) Int. Cl. G06Q 30/02

(52) U.S. Cl. CPC G06Q 30/0207
USPC 705/14.35

(57) ABSTRACT

An e-commerce system for managing group buy operations has a group server (14) to hold data relating to all purchases of the same product or range of products over a time period and outputs data relating to a projected price curve and current membership of the group, based on a pricing engine (12) for display at an e-commerce portal.

### TECHNICAL FIELD

The present invention relates to e-commerce platforms for facilitating group purchasing.

### BACKGROUND ART

It is well established that buying in bulk attracts discounts. Computer implemented e-commerce platforms have taken advantage of this in order to offer discounts. Examples of group buying models include eHaggle and Groupon. See, for example, PTL 0001: U.S. Pat. No. 7,822,648 B (EHAHGGLE LLC). 2010 Oct. 26.

More recent platforms have overcome the difficulties previously encountered in forming groups from individuals and SMEs by using the power of social networking.

Historically, bulk buying has been a business to business (B2B) process benefiting traders and sellers. Some more recent e-commerce solutions have implemented processes and systems for business to consumer (B2C) transactions allowing bulk buying. Typically, as in Groupon and eHaggle, they collect consumer interests (i.e. collective demand) and match with the pre-determined supply (previously negotiated with the supplier). The offer to the consumer is made at a reduced price on meeting demand/supply equilibrium. If the equilibrium is not achieved, the offer fails.

There are also systems (including Groupon and Livingsocial) which provide Group price offers purely based on specific opportunities for a very short period (usually a day). These platforms are usually used by the sellers as an advertising mechanism by giving away offers on specific days or for a set duration. This approach does not allow users to buy what they need; rather it allows a push approach from the seller.

These platforms lack a catalogue or have a very small catalogue for users to browse and select items they need to buy. Therefore they do not provide a satisfactory shopping experience to the user.

With all of these platforms, significant problems remain as it is still necessary to wait for a group to be assembled in order to achieve a discount.

In many e-commerce platforms “Instant Buy” options are offered to allow consumers to buy a product without waiting for, say, an auction period to finish. However, consumers who use such options feel frustrated if they find that others have received a better price later.

A solution offered by Ezoka.com Inc. as described in a Cisco Systems Case Study on “Making Big Business of Small Business” of 4 Apr. 2002 proposed smart management of buying cycles so that goods are shipped immediately and that, wherever it is applicable, customers receive further rebates on already low prices when the final bulk order is negotiated and placed. The Ezoka business failed at about that time. The model was aimed at large organizations and business communities rather than the private buyer.

Falling price or price drop auctions are run on shopping channels such as www.price-drop.tv and also on supporting websites. In this type of limited time auction a set quantity of product is available and the first users to commit to ‘buy now’ agree to buy the product at the final price. It is also possible for a user to bid by entering a price they are prepared to pay if the price drops to that level. While everyone pays the lowest price, these auctions are of necessity conducted over a very short duration where they are promoted on TV. A user is also unable to predict the manner in which the price will fall. Suppliers use these auctions for clearance of old products.

Currently a consumer purchasing a specific product from a retailer, whether online or in-store or directly from an OEM is treated as an individual whose purchase is isolated from the purchases of other consumers of the same product from the same retailer/OEM. There are no incentives for individual consumers to promote the product they have bought utilizing their social network to create a bulk/volume sale. This is seen as a missed opportunity to promote or advertise virally among a socially networked and active generation.

### DISCLOSURE OF INVENTION

All of these systems demonstrate problems surrounding the creation of a group. By eliminating the need for a pre-existing group and permitting purchase at any time during a Group Offer period, a group management system of the present invention aggregates individual purchases made at any time during the specified Group Offer period and applies, equally to all purchases made during that period, a further incentive in the form of a bulk/volume discount which is credited to each purchase made during the Group Offer period. Using this system maximizes the potential of personal endorsement of each Group Offer by enabling consumers who purchase product during the offer period to directly advertise market and promote the Group Offer to their social networks. The system of the invention thereby eliminates the major delay or waiting problem, delivers a fair discount to all, and incentivises participants to directly promote the Group Offer to their social network.

Much of the system of the invention is computer- implemented in software and includes conventional order processing, payment and fulfilment modules. However, the major technical requirements to achieve the solution of the invention are a group server and communications and scheduling components to manage so-called Group Basket information, namely data relating to all individual purchases of the same product or range of products (Group Offer) over a time period by users who become members of the buying group automatically on purchasing the Group Offer products/services on offer. The group server outputs data under the control of the communications and scheduling components enabling dynamic updating of the Group Basket data and the display, on a web page in a user portal, of a projected price curve as a function of the number of items purchased by members of the group.

More specifically the present invention provides a system for supporting the provision of group offers on at least one computer-implemented e-commerce platform comprising

(a) a pricing engine to generate a product price curve from a stored algorithm and data supplied by a merchant relating to a product or range of products within a single Group Offer offered for sale by that merchant; and

(b) a group server including a database and supporting software to receive from an e-commerce platform and to hold data relating to all individual purchases of the same product or range of products within the Group Offer over a time period and to output data relating to a projected price curve and number of items purchased by the current membership of the group to the e-commerce platform and data on expiry of the time period on the final price.

The system preferably provides a group basket accessed through a portal which dynamically retrieves, captures and updates group activities from the database in the group server including data on group membership, items purchased and items returned and adjusts and updates in real time the performance of the group towards achievement of the maximum discount available.

Other features of the invention are set out in the claims.

The present invention employs a group pricing engine which calculates a unit price as a function of the group size. The system permits users to buy at any point during the period of the Group Offer paying the displayed initial selling price and potentially receiving a discount on closure of the Group Offer based on the total number of purchases made by group members during the Group Offer period. This novel computer implemented e-commerce platform allows users to receive their purchases without delay by paying the initial selling price but avoids the frustration of losing a discount, as they will receive a credit on closure of the Group Offer. The amount of this credit is determined by the number of items purchased by group members at the point of closure, amongst other factors, and therefore provides an incentive for early purchasers to engage with their social networks to increase the size of their prospective discount.

The engine which lies at the heart of the e-commerce platform relies on an understanding of supply and demand economics. Pricing models for collective purchasing have been discussed in academic papers such as “Pricing Strategy Analysis for Collective Purchasing E-Commerce” by Yung_Ming Li, Ting-Kai Hwang and Ping-Wen Chen published in 2006 by Institute of Information Management National Chiao Tung University, Taiwan. It is a feature of the e-commerce platform of the invention that the price curve generated from the data relating to an offered product is displayed to prospective purchasers along with the current size of any existing group of consumers thus enabling them to more accurately predict the final price/scale of bulk/volume discount.

The system allows a merchant to establish demand without presenting their product as being in a clearance state. The quantity available need not be displayed in order to pressurize users into making a buying decision. However the user is able to see immediately how contributing to the demand will affect level of further discount achievable on the initial selling price paid.

The system can be used with a stand-alone e-commerce platform with its own catalogue of products where every product in the catalogue is on a Group Offer. The catalogue consists of departments each of which has categories with products listed under an appropriate category. Such a stand-alone system enables individual merchants to upload products to the catalogue and make their own Group Offers. It is therefore possible for the catalogue to contain more than one Group Offer for the same product offered by different merchants. The price curve for each product is generated by the group pricing engine. This means that if a user wants to buy a particular product such as a specific TV model/brand, the user can browse to find all Group Offers for that model/brand offered by various merchants.

The essential elements of the system can also be integrated with existing third party e-commerce platforms allowing established retailers to offer any or all of their products as a Group Offer.

The system is designed to facilitate sending of invitations to family and friends using various methods such as e-mail and links to number of social networking sites. The system can also store and maintain contact details of family and friends which can be used to send group e-mails.

Typically e-commerce platforms are addressed to purely national audiences because of the difficulty presented by customs barriers to the import of single items. However identical or similarly specified products are often available in different countries via local suppliers (OEMs or distributors) and many users of social networks have friends and families internationally. The system of the present invention permits suppliers with multi-national distributors to take advantage of the power of social networking to promote across borders and develop overseas markets without local advertising by offering as a single Group Offer country specific product across different countries and aggregating the purchases made by users in the different countries for the purposes of determining the discount achievable. This is possible as the group server is able to receive data from and output data to multiple merchants who subscribe to a single Group Offer.

Users participating from different countries in a Group Offer collectively count towards the number of group members thereby dropping the price of the product offered in each country benefiting everyone in the group irrespective of their country/currency of participation.

The group pricing engine produces the price curve for each country in local currency depending on the location of the user, but the size of the discount achievable is determined by the total number of products purchased globally.

### BRIEF DESCRIPTION OF DRAWINGS

In order that the invention may be well understood, an embodiment thereof will now be described, by way of example only, with reference to the accompanying diagrammatic drawings in which:

FIG. 1 shows a diagrammatic representation of the group purchasing system supporting a number of e-commerce platforms;

FIG. 2 shows the simple cycle of events occurring during use of the e-commerce platform;

FIG. 3 shows an example of a web page structure for a product where a Group Offer is available:

FIG. 4A shows a detail of a Group Basket web page displayed to a user who has previously made a purchase under a Group Offer; and

FIG. 4B shows a detail of a group basket web page displayed to the user who is about to make a purchase under a Group Offer.

### MODE FOR CARRYING OUT THE INVENTION

Many consumers are now accustomed to shopping by browsing retailer websites. Each of these websites will offer such users access to a range of products and offer shopping basket functionality.

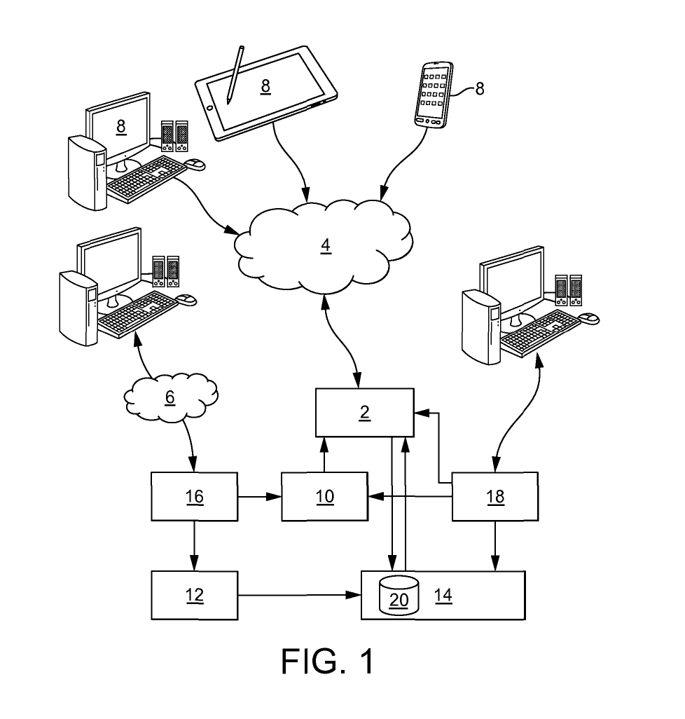

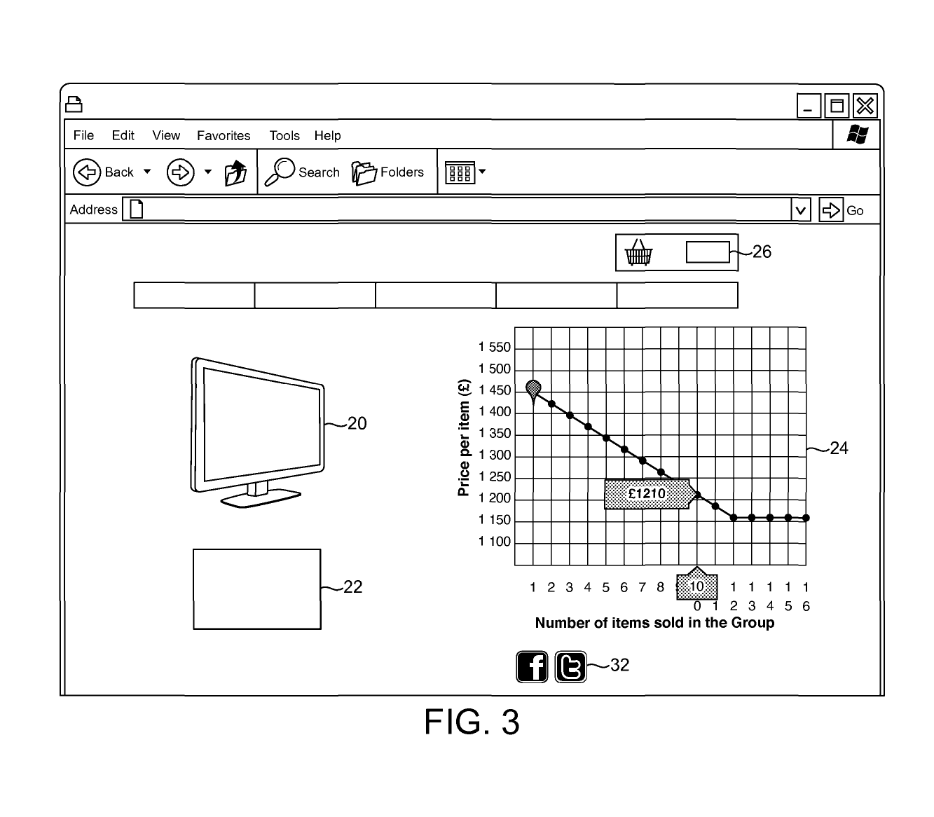

The basic structure of a system for supporting the provision of Group Offers on a single computer-implemented e-commerce platform is shown in FIG. 1. Users can access an e-commerce platform 2 via the Internet 4 in any conventional manner using browser software on PCs, tablets, smart phones or other mobile devices 8. The e-commerce portal 2 is supported by the usual management and payment modules in any e-commerce platform server 10. A catalogue of products is stored in a database in order to enable webpages to be dynamically created for displayed to a user of each product on offer. The portal 2 will also provide a shopping basket so that selected products can be purchased and gateways to payment of fulfilment services. It also provides access to a group basket which dynamically retrieves, captures and updates group activities from the catalogue database and the group server including group membership, items purchased and items returned and adjusts and updates in real time the performance of the group towards achievement of the maximum discount available. A pricing engine 12 and a group server 14 are also provided. A merchant portal 16 enables a merchant to access the pricing engine 12 and import both pricing data and product data into the catalogue. The merchant uses a secure Internet connection 6 to access the merchant portal. An admin portal 18 for management access to the group server 14 is also provided. The group server holds the Group Offer catalogue database which stores product description and pricing data generated by the pricing engine 12 for each group offer to facilitate its publication to webpages at the portal 2 (see FIG. 3).

The Group purchasing system is built on a flexible, Services-Oriented Architecture (SOA). It includes common services and business logic that are specific to an organisation. Using a layered approach, the platform reduces redundancy by maximizing the re-use of these common services through different modules that are easily customised to support the unique needs of different businesses and users. These layers include:

Infrastructure Services Layer (ISL)—the foundation built in the group server 14, providing the basic modules and components for building and integrating generic software modules as part of a complete business solution.

Business Services Layer (BSL)—encapsulates the business logic that forms the software core of the system executed between the workflow processes in server 10 and the group server 14. It is easy to customise to suit customer organisation requirements and because the system is SOA-based, it integrates easily with legacy and 3rd-party systems.

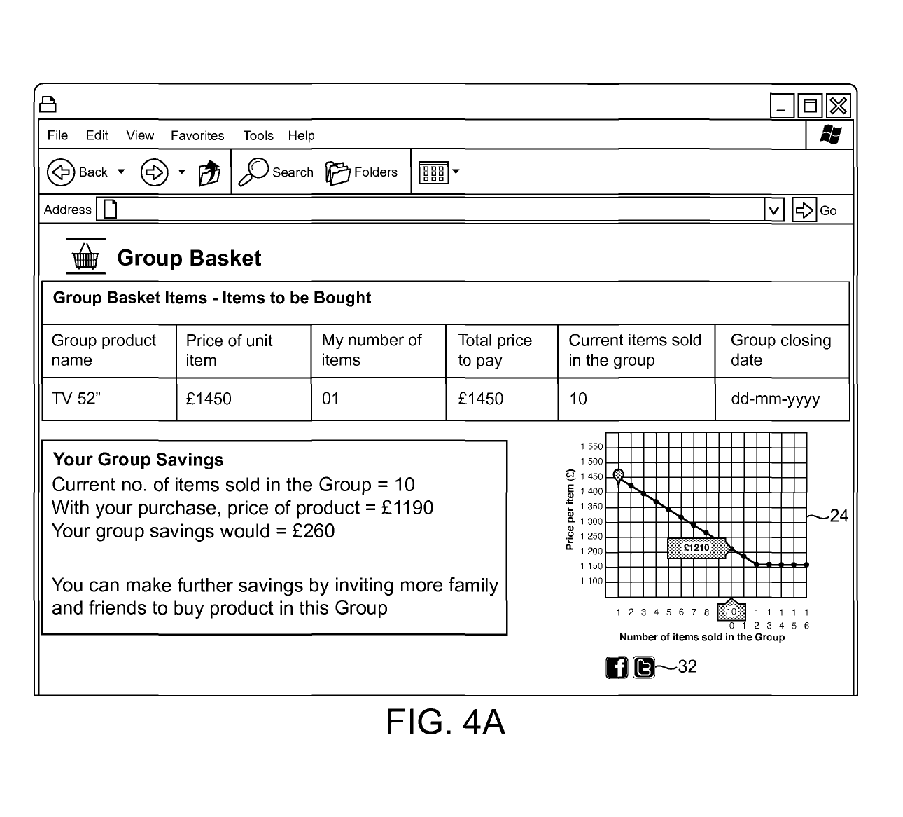

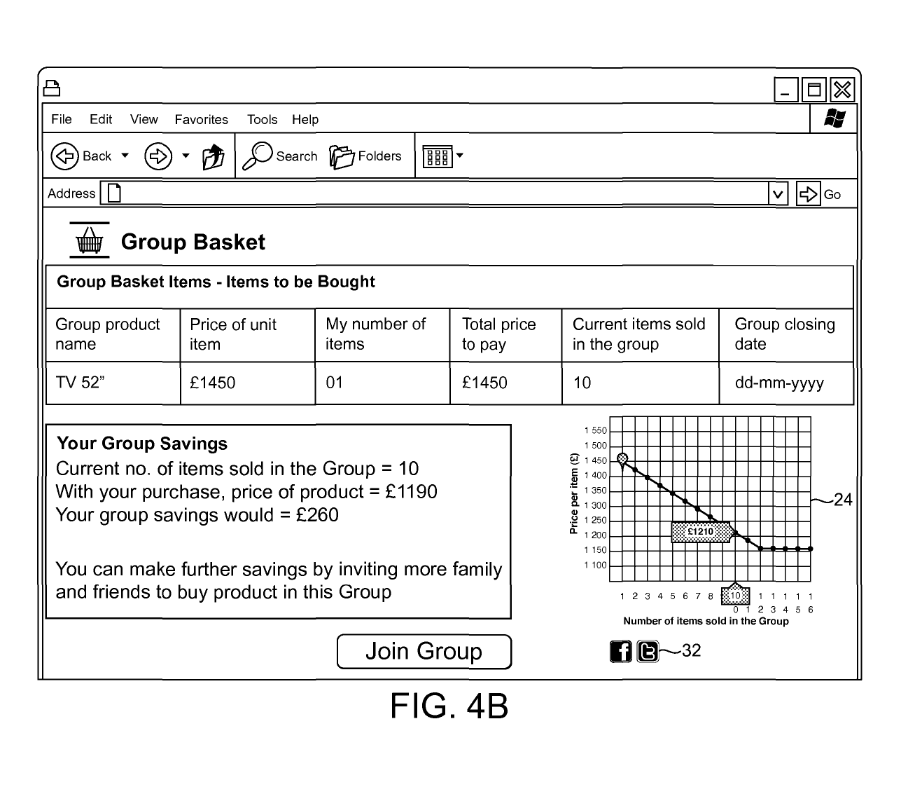

Presentation Layer (GPL)—includes the front end e-commerce portal 2, a Group Basket display (see FIG. 4A/B), the merchant portal 16 and the admin portal 18. The e-commerce portal is the online shopping website where users can buy products and the Group Basket data, in particular, the product price curve is also visible on the shopping website 2 and enables users to monitor the performance of a product Group Offer. The merchant portal 16 is accessible to merchants to provide product information and manage inventory, orders, payments etc. The admin portal 18 is the system management portal and accessible to central administrators of the online retail websites.

The software for the system is developed using PHP and MySQL database. Its flexible, open architecture integrates seamlessly into different development environments. The platform is also highly scalable. The group purchase platform is built on an industry-standard tech-nology stack that is easily customised and configured and is SOA-based for easy integration with legacy and 3rd party systems. The system has transformed what initially was a highly complex set of requirements to a set of the layered, loosely coupled, modular subsystems.

The system is also ideally suited for Software as a Service (SaaS) based on a multi-tenant architectural model through which a customised and reliable solution can be delivered to various customers as a single application instance.

### User Experience

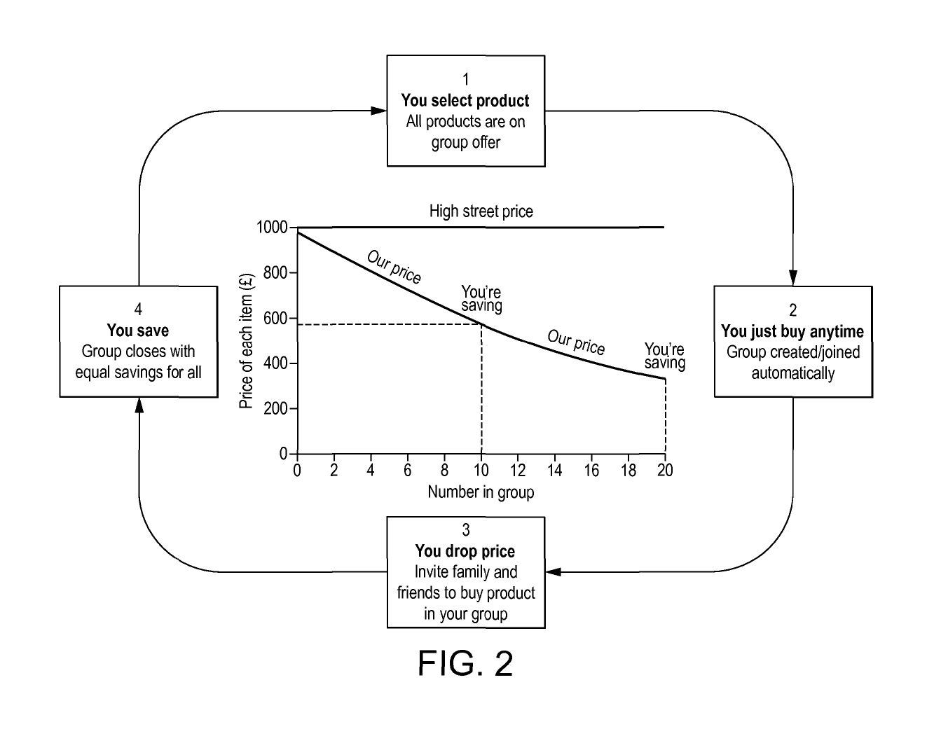

The overall user experience is illustrated in FIG. 2. The user first browses the catalogue of an e-commerce platform 2 for any particular type of product in which he is interested. By using this platform, unlike others, the user knows that all products within the catalogue are on Group Offer and that his purchase will be part of a bulk purchase. Secondly, the user can make the purchase at any time during the Group Offer period. Where the user is not the first to purchase he will automatically join the buying group associated with the Group Offer selected or, if he is the first purchaser the purchase will automatically trigger the formation of the buying group connected with that Group Offer and the commencement of its associated Group Offer period. Users who return to the site to make additional purchases under the same Group Offer will have those purchases attributable to them and their buying group. Once a group has been established the group will be open for a fixed number of days, for example 8 to 16 days. When the user buys, he pays the initial selling price specified and receives the group savings after the Group Offer closes based on the total number of items sold in the group. Thirdly, once a product has been identified, he can use social networking connections to invite family and friends to join the group and bring down the price for himself and all other members of the group. Fourthly, when the group closes each member receives his group savings discount, which is equal to the difference between the initial selling price paid and the group price based on the total number of items sold in the group. The savings are credited to each group member within, for example 14 days of the Group Offer closing. Once the group is closed, the system default, which can be over ridden by the merchant, sets up a new Group Offer for the same product/service on the same terms within a set period of the original Group Offer closing. A new user purchasing a product under the terms of the new Group Offer will then start a new group for the same product. The outcomes of previous groups can be displayed as part of the product information on a Group Basket part of the web page.

As part of the product data provided by the merchant, there will be a recommended retail price, an initial selling price: the point at which the price curve commences, and a lowest selling price: the price at which the price curve levels out and which represents the maximum discount relative to the initial selling price that the user can obtain. At step two, when the user buys a product, the order will be fulfilled and the merchant will receive a payment equivalent to the lowest selling price, and the user will pay the initial selling price. On closure of the Group Offer time period, the final selling price will be established and the difference between that and the initial selling price paid by the user will be credited to the user's account. If the final selling price is above the lowest selling price the merchant will also receive a credit. The data relating to the transactions is stored in the group server and the necessary outputs controlled by a communications and scheduling module implemented within the group server 14.

A typical product web page on an e-commerce portal is shown in FIG. 3. In addition to the usual image 20 of the product offered for sale and product specification and information 22, there is a Group Offer area 24 which displays information about the Group Offer, in particular a pricing curve and status information on the group such as whether it has started and how long it has to run. The pricing curve is preferably interactive so that the price flag or the number flag can be clicked on and moved by the user in order to display detailed pricing and group size information depending upon the position on the curve. When a user purchases a product that is part of Group Offer such as using a Buy Now button 26, this action will result in the user subscribing to the Group Offer and the user's purchase being added to the Group Basket with all other purchases made under the same Group Offer. Some Group Offer information may only be available to view when a registered portal user has bought a product. The actual purchase of the product at the initial price is otherwise subject to the normal shopping basket process familiar to web users. Information gathered by the e-commerce portal will be fed to the e-commerce platform server and that necessary for management of the Group Offer will be passed to the group server 14. Users must be registered so that they can receive messages about the state of the Group Offer such as its size and imminent closure. Users who purchased while the Group Offer was running will receive credits and the information for this will be provided to the e-commerce platform from the group server 14.

FIGS. 4A and 4B show a Group Basket displayed to the user once he has entered the shopping basket area. For the user in FIG. 4A, it is assumed that he has already purchased and paid the initial selling price for the product and is checking back to see how his group savings are growing. Note that he also sees the date on which the group closes in order to encourage further promotion via social networking to improve sales and achieve maximums discount. FIG. 4B shows a display for a user who in the process of buying a product. Note that the in this embodiment, he is requested to pay the initial selling price, £1450 in this example, even though he is already expecting a substantial discount. This approach makes the processing of returns simpler and where credit cards are used many users will see their discounts in the same statement as the initial payment.

Note that the number of products available is not displayed as is customary in price drop auctions. The pricing engine is designed to achieve price equilibrium and balance supply and demand by determining the optimum size of the group and duration of the Group Offer. It will be seen that the product price curve becomes a horizontal line (lowest selling price) at some optimal group size at which supply and demand are in equilibrium. Group lifetime brings the group to a close at or before that equilibrium size in order to maintain incentive for new group members. The slope of the curve for number of purchases made by members and the data provided on the web page on the best available discount demonstrate clearly to a user how promoting that product personally can bring benefit in the form of an increased discount and a lower price.

Other space on the pages can be used for advertising, best deal information, and links to social networking sites 32 and other navigational tools.

### The Merchant Portal and Pricing Engine

Product data includes details and images relating to the product for sale as well as data necessary to enable the product price curve to be generated by the pricing engine 12. The product price curve represents the price to a user as a function of the number of purchases made by members in a buying group at the time the Group Offer closes. The product data must therefore include:
lowest selling price
initial selling price
territories in which the product is available for delivery
any restriction on numbers of product available together with any geographical constraints
period of availability
number of Group Offer items purchased by group members.

The pricing engine can optimize the time a group is open in order to develop demand and also set the optimum size. The pricing engine is designed to allow the available profit margin to be shared in an equable and transparent way as between merchant and buyer. Inputs to the pricing engine 12 can be supplied by the platform operator and also by the merchant as well as being collected by searches over the Internet of other price comparison and retail websites.

Group Offers for a specific product can form and close with the subscribed users becoming buyers. Once the group is closed, the system default, which can be over ridden by the merchant, sets up a new Group Offer for the same product/service on the same terms within a set period of the original Group Offer closing.

Order fulfilment will be direct from the OEM supplier or his geographically local distributor.

The aim of the system of the invention is to enable a substantial catalogue to be maintained so that merchants can establish demand for products via established e-commerce platforms. Unlike other platforms which are almost exclusively used for clearance and end of life items, Group Offers which aggregate and incentivise individual purchases and use a flexible pricing engine are also suitable for mainstream products desired by consumers.

The pricing engine 12 generates a product price curve for each product according to a stored algorithm. The merchant may be able to select between different algorithms that deliver different product price curves. A product price curve generated by some of these algorithms may be a step function or a linear function, though a more complex polynomial curve is shown in the embodiment. Merchants can control the approach they take and the initial and lowest selling prices that they set and also retrieve data from their own Group Offers as well as other data that may be made available by the platform operator to assist in the optimisation of their pricing strategies.

### Group Management

A group is initiated when a user visiting a product web page is the first to buy. The Group Offer life as determined by the merchant using the pricing engine, then starts. Any subsequent purchasers of the same product will automatically join this group. Details of all buyers are made available to the merchant in real time so that products can be dispatched and delivered within prescribed time periods. The user and any other user of the platform can promote the Group Offer in order to reduce the price. The geographical availability is displayed on the page so that a user interested in a high value item can encourage overseas contacts to contribute with him in achieving a price reduction.

Every purchaser receives his product immediately and can be allowed to return it within a specified period. Returns are notified and processed via the portal ensuring the merchants have access to the information in real time. Every return is fed back into the group server and will result in real time adjustments to key group data including the group membership, the total number of items purchased by the group members, the product price curve and the group basket.

At the end of the lifetime of the Group Offer, the Group members will receive a sum equal to the difference between the price they paid and the final price as illustrated by the pricing curve which in turn is determined by the number of items sold during the Group Offer period.

### Variations

The embodiment described is a standalone platform. It will be appreciated that the group server could provide services to a number of independent e-commerce platforms with Group Offers that are either exclusive to each platform or shared between one or more platforms.

The displays shown in the figures are adapted for users using relatively large screens. It will be appreciated that the displays can be adapted to suit smaller mobile screens.

1. A system for supporting the provision of group offers on at least one computer-implemented e-commerce platform, comprising
a pricing engine to generate a product price curve from a stored algorithm and data supplied by a merchant relating to a product or range of products within a single group offer offered for sale by that merchant; and
a group server including a database and supporting software to receive from an e-commerce platform and to hold data relating to all individual purchases of the same product or range of products within the group offer over a time period and to output data relating to a projected price curve and number of items purchased by the current membership of the group to the e-commerce platform and data on expiration of the time period on a final price.

2. The system of claim 1, further comprising a group basket accessed through a portal which dynamically retrieves, captures and updates group activities from the database in the group server including data on group membership, items purchased and items returned, and adjusts and updates in real time the performance of the group towards achievement of a maximum available discount.

3. The system of claim 1, wherein the group server initiates the time period on receiving data relating to a purchase within a group offer if no group offer for that product is then running.

4. The system of claim 1, wherein a group offer may be available on a single e-commerce platform or a subscribed group of e-commerce platforms and the group server stores data relating to the e-commerce platforms subscribing to each group offer.

5. The system of claim 4, wherein the computer-implemented e-commerce platforms are located in different countries and the number of items is accumulated in the group server amongst users from different countries in which the product is available.

6. The system of claim 1, further comprising a merchant portal to enable a merchant to access the pricing engine and specify an initial selling price and a lower selling prices within each group offer and select an algorithm to generate the product price curve.

7. The system of claim 6, wherein the product price curve is a stepped function.

8. The system of claim 6, wherein the product price curve is a linear function.

9. The system of claim 2, wherein the group server initiates the time period on receiving data relating to a purchase within a group offer if no group offer for that product is then running.

10. The system of claim 2, wherein a group offer may be available on a single e-commerce platform or a subscribed group of e-commerce platforms and the group server stores data relating to the e-commerce platforms subscribing to each group offer.

11. The system of claim 9, wherein the computer-implemented e-commerce platforms are located in different countries and the number of items is accumulated in the group server amongst users from different countries in which the product is available.

12. The system of claim 2, further comprising a merchant portal to enable a merchant to access the pricing engine and specify an initial selling price and a lower selling prices within each group offer and select an algorithm to generate the product price curve.

13. The system of claim 12, wherein the product price curve is a stepped function.

14. The system of claim 12, wherein the product price curve is a linear function.
